(19) United States
(12) Patent Application Publication
(10) Pub. No.: US 2017/0135295 A1
(43) Pub. Date: May 18, 2017

(54) Structured Water Irrigation

(71) Applicant: Rick Americo Laurenzi, Colorado Springs, CO (US)

(72) Inventor: Rick Americo Laurenzi, Colorado Springs, CO (US)

(21) Appl. No.: 15/351,621

(22) Filed: Nov. 15, 2016

Related U.S. Application Data
(60) Provisional application No. 62/256,372, filed on Nov. 17, 2015.

(51) Int. Cl. A01G 25/00; C01B 5/00; A01G 7/00; C02F 1/68; C02F 1/461

(52) U.S. Cl. CPC A01G 25/00; C02F 1/68; C02F 1/4618; C02F 1/46109; A01G 7/00; C01B 5/00; C02F 2001/46195; C02F 2001/4619; C02F 2001/46138

(57) ABSTRACT

The growth rate of plants, health of plants, and plant yield are improved by the use of structured micro-water for irrigation. Water with an Oxidation Reduction Potential (“ORP”) reading of −1 mV to −1100 mV and containing dissolved hydrogen from 10 to 10,000 ppb has smaller water clusters and is easier for a plant to absorb through the plant's aquaporins. Structured micro-water having these parameters is obtained by equipment employing electrolysis/ionization or through the addition of certain chemicals.

### CROSS-REFERENCES TO RELATED APPLICATIONS

This application claims the benefit of U.S. Provisional Application Ser. No. 62/256,372 filed on Nov. 17, 2015 titled “STRUCTURED WATER IRRIGATION” which is incorporated herein by reference in its entirety for all that is taught and disclosed therein.

### BACKGROUND

### Field of the Invention

The invention is in the technical field of agriculture irrigation. This invention relates to methods for enhancing plant growth rate, plant health, and greater quality and quantity of plant yield.

The present invention is directed to:

a. Using structured water clusters having a group of specific characteristics for increased absorption, accelerated plant growth, better plant health, and greater quality and quantity of plant yield; and

b. Increasing the quantity of dissolved hydrogen in the water for accelerated plant growth, better plant health, greater quality and quantity of plant yield, and reduced oxidative stress.

### SUMMARY

This Summary is provided to introduce in a simplified form a selection of concepts that are further described below in the Detailed Description. This Summary is not intended to identify key features or essential features of the claimed subject matter, nor is it intended to be used to limit the scope of the claimed subject matter.

Agriculture irrigation using structured water accelerates plant growth rate and improves the health of the plants. Water with a millivolt reading of −1 mV to −1100 mV and containing dissolved hydrogen from 10 to 10,000 ppb (parts-per-billion), referred to as structured micro-water, has smaller clusters of water molecules, thereby increasing water absorption rates, decreasing oxidative plant stress, and increasing the quantity of nutrient-dissolved hydrogen available for the plant (a major component of plant cells).

To obtain structured micro-water having these parameters, the water needs to be treated with equipment employing custom electrolysis/ionization processes or use a variety of chemicals to change the structure of the water.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together. When each one of A, B, and C in the above expressions refers to an element, such as X, Y, and Z, or class of elements, such as X1-Xm, Y1-Yn, and Z1-Zo, the phrase is intended to refer to a single element selected from X, Y, and Z, a combination of elements selected from the same class (e.g., X1 and X2) as well as a combination of elements selected from two or more classes (e.g., Y1 and Z3).

It is to be noted that the term “a entity” or “an entity” refers to one or more of that entity. As such, the terms “a” (or “an”), “one or more,” and “at least one” can be used interchangeably herein. It is also to be noted that the terms “comprising,” “including,” and “having” can be used interchangeably.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof, shall include all those described in the summary of the invention, brief description of the drawings, detailed description, abstract, and claims themselves.

Unless the meaning is clearly to the contrary, all ranges set forth herein are deemed to be inclusive of the endpoints.

### BRIEF DESCRIPTION OF THE SEVERAL VIEWS OF THE DRAWINGS

FIG. 1 shows a representation of water clusters for structured micro-water and regular tap water.

FIG. 2 shows a representation of plant aquaporins and their narrow ionically charged channels used for water transport through plant membranes.

FIG. 3 shows a water sample in a petri dish freezing and being observed by a microscope.

FIG. 4 shows a frozen water crystal formed from a water sample having an ORP of +320 mV and no dissolved hydrogen.

FIG. 5 shows a frozen water crystal formed from a water sample having an ORP of −375 mV and dissolved hydrogen of 400 ppb.

### DETAILED DESCRIPTION

Referring now to the Figures, like reference numerals and names refer to structurally and/or functionally similar elements thereof, and if objects depicted in the figures that are covered by another object, as well as the tag line for the element number thereto, may be shown in dashed lines. Unless the meaning is clearly to the contrary, all ranges set forth herein are deemed to be inclusive of the endpoints.

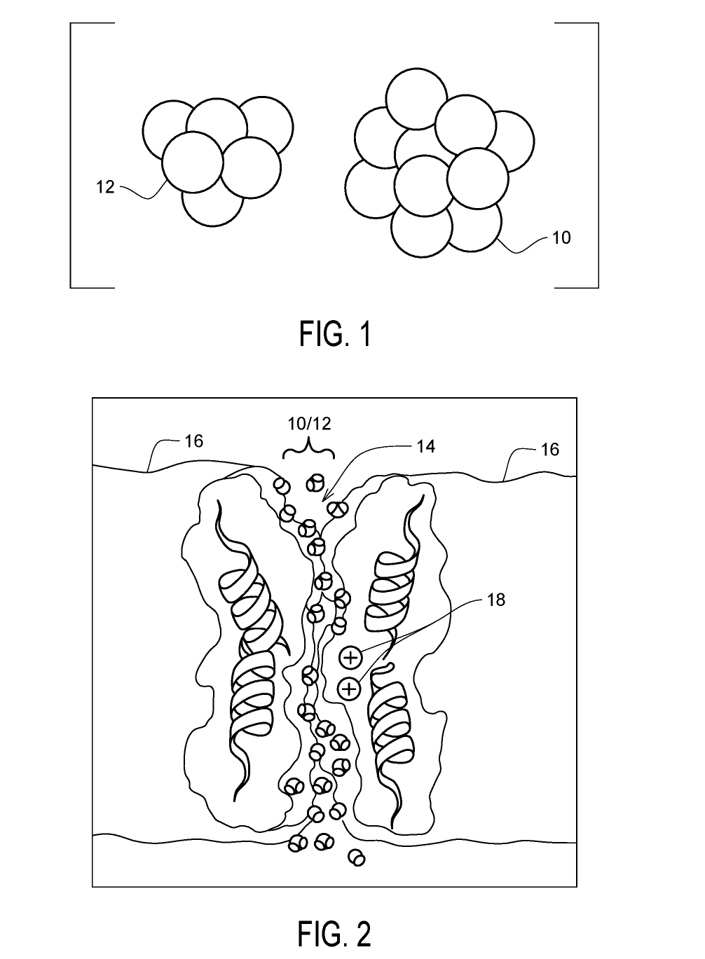

FIG. 1 shows a representation of water clusters for structured micro-water and regular tap water. Referring now to FIG. 1, structured micro-water with an Oxidation Reduction Potential (“ORP”) measured in millivolts from −1 mV to −1100 mV and may also contain dissolved hydrogen from 10 to 10,000 ppb is used as source water for plants prior to adding nutrients, chemicals, or amendments. Structured micro-water is obtained by mild electrolysis or chemical treatment. Water with a pH of seven is approximately neutral on the pH scale of zero to fourteen. Tap water redox (reduction-oxidation reaction) potential measured with an ORP gauge can be +100 mV up to +800 mV. Because it has a positive redox potential, it is apt to acquire electrons and oxidize other molecules. Structured micro-water, on the other hand, has a negative ORP of approximately −1 mV to −1100 mV. This means it has a large mass of electrons ready to donate to electron-thieving active oxygen. Inside an electrolysis unit, the water passes into an electrolysis chamber equipped with a platinum-coated titanium electrode where electrolysis takes place. Cations, positive ions, gather at the negative electrodes to create cathodic water (structured micro-water or reduced water). Anions, negatively charged ions, gather at the positive electrode to make anodic water (oxidized water). Custom membranes, such as Teflon™-ceramic membranes, separate the negative electrode from the positive electrode. The oxygen will pass through the membrane, and the hydrogen remains on the other side. Through electrolysis, structured micro-water not only gains an excess amount of electrons (e-), but also the clusters of H₂O are reduced in size from as large as forty to sixty molecules per cluster, such as large water cluster 10 shown in FIG. 1, to as small as two to six molecules per cluster. Electrolysis yields structured micro-water with a negative potential. The smaller water clusters, such as micro-water cluster 12 shown in FIG. 1, have a much easier time crossing the cell membrane through the aquaporins (portals into the cell). The smaller structured micro-water cluster 12 is hexagonal in shape, an organized matrix. The change in millivolt reading will vary greatly depending upon the source water composition.

Another factor affecting the ability to create structured micro-water is the amount of dissolved solids, or minerals, present in the source water, which can vary greatly from different points of origin for the source water. Source water can vary greatly in the amount of total dissolved solids (in parts-per-million) and whether those dissolved solids are alkaline or acidic minerals.

In one embodiment of the invention, source water is first filtered to optimize the water for electrolysis by removing unwanted dirt, chemicals, excess minerals, biologicals, and any other substances that would be detrimental to electrolysis. Various methods known in the art may be utilized, including but not limited to, reverse osmosis, ceramic micron filters, kinetic degradation fluxion media, charcoal filters, and nano filters to enhance the quality of the water before creating the structured micro-water. One skilled in the art recognizes that there must be some dissolved solids in the source water in order for the electrolysis process to work.

Water clusters form into all different sizes and electrical charges. The size of water molecule clusters, and their measurable electric charge, affect their absorption rate into a plant. Water clusters that are larger in diameter, such as large water cluster 10, have more water molecules per cluster and a positive (+) millivolt ORP reading (example: +50 mV to +800 mV). The size of these large water clusters 10 and their positive electrical charge makes it harder for plants to absorb. Plants absorb most water through ionically charged channels called aquaporins 14 as shown in FIG. 2. Aquaporins 14 are water-specific pores that account for most of the passage of large water clusters 10/micro-water clusters 12 across biological cell membranes 16. Aquaporins 14 are narrow channels that large water clusters 10 have a harder time going through. At the center of the narrow passageway are positively charged residues 18, which prevent the movement of large positively charged water clusters 10 there through. The associated positive ORP mV charge of large water clusters 10 makes these clusters “sticky.” Ions such as H+ will not be able pass across due to the presence of the positive charges in the aquaporin 14 passageways. Aquaporins 14 selectively funnel the movement of water across the cell membranes 16. Water clusters that are smaller in diameter, such as micro-water clusters 12, and have an excess of electrons (ions or a negative ORP mV reading) are easier for plants to absorb through their aquaporins 14. This will increase hydration and plant health, and thus accelerate plant growth rates and plant sizes.

Micro-water clusters 12 with a negative millivolt ORP charge (example: −1 mV to −1100 mV) do not occur in nature from rain water, ground water, surface water, or municipal water sources. These micro-water clusters 12 have to be created with custom ionization equipment, or the addition of chemicals to the water. Water clusters with a −1 to −9 mV ORP charge may have some benefit, but the −1 mV to −1100 mV is more beneficial. The larger the negative millivolt value, the more beneficial the structured micro-water becomes.

### Size Of A Water Cluster And The Electrical Charge

The term “cluster” is used because water molecules do not exist by themselves singularly in nature. This means that there are no single water molecules by themselves floating around in the air, or in a river creek, or in a spring. Water molecules are always in existence with many other molecules. Robert Bukowski and Krzysztof Szalewicz, both professors at the University of Delaware, proved that water clusters could exist as small as two molecules per cluster. This rarely happens, and most tap water clusters in a municipal system, where water is pressurized to flow through a town's water pipes, usually have clusters with 40 to 60 molecules per cluster, but that number can be even larger in some cases.

When water clusters are physically large in size, they are simply harder to absorb by any plant or animal than water clusters that are small in size. In 2003 a Noble Prize was awarded to Peter Agre for proving the existence of water channels in plants and animals called “aquaporins.” Aquaporins are the major highways by which water is absorbed by the plant. The roots of a plant have lots of aquaporin channels and these channels are very small in size. An easy to understand analogy is that a plant's aquaporin is like a doorway into a house. A regular house door has an opening of about six-feet tall by two-feet wide. A large water cluster that has 40 to 60 molecules is like a ball ten-feet in diameter trying to come in through the six-feet-by-two-feet house door. It would be pretty tough for the ball to go through the door, and it would be a slow process to squeeze through the door. This is not very good for the maximum amount of water a plant could use. But if a smaller water cluster came by that was about two to six molecules per cluster, this would be like a ball one-foot in diameter trying to get though the house door. It will go right in as fast as it can travel. This would be a better and quicker way to hydrate the plant. So, a simpler way to allow a plant to absorb water easier and quicker is through a smaller diameter or size of a water cluster.

### Checking The Size Of A Water Cluster

A water cluster's size has a direct correlation with its electrical charge. A larger water cluster will be electron hungry. It will want to steal electrons from everything around it. Stealing electrons from a plant or animal causes oxidative stress and the formation of free radicals. The more free radicals there are, the less healthy a plant or animal will be. When you give electrons to a plant or animal, you reduce oxidative stress and you reduce the formation of free radicals. This oxidative stress can be measured in millivolts by a gauge called an ORP meter, which is measured in millivolts with a positive or negative charge. Any water cluster with a positive (+) millivolt reading is electron hungry and will be stealing electrons from everything around it. This is bad for plant health because it causes oxidative stress and the formation of free radicals. Any water cluster with a negative (−) millivolt reading will be electron rich, sharing electrons with everything around it, and stopping oxidative stress and the formation of free radicals. This is called antioxidant water and is healthier for plants and animals.

### Electrical Charge Related To Water Cluster Size

A water molecule has an oxygen atom in the center with two hydrogen atoms attached. It is the surface of the hydrogen atoms where the electrons are shared. The more surface area of hydrogen atoms means the water would be electron rich.

A simple geometry example is to compare the surface area of ping pong balls to that of beach balls in a specific volume. In this example, the ping pong balls represent small water clusters and that the beach balls represent large water clusters. Assume we have a room that is ten-feet high by ten-feet wide by ten-feet long. This room has a volume of 1000 cubic feet. Beach balls that are two-feet in diameter are placed in the room until the room is totally filled. We can count the number of beach balls (or large water clusters) and we can calculate the surface area of all of the beach balls. If we fill that same room with ping pong balls that are one inch in diameter until the room is filled, there will be more ping pong balls in the room than were beach balls. We can count the number of ping pong balls (or small water clusters) and can again calculate the surface area of all of the ping pong balls that were in the room. The sum total surface area of all of the ping pong balls will be much larger than the sum total surface area of the beach balls. The same is true for water clusters—small water clusters will have more cumulative surface area than large water clusters.

It is the surface area of the hydrogen atoms in the water molecules and water clusters that share the electrons. The more surface area the more electrons are shared. Smaller water clusters are the electron rich waters clusters, and the large water clusters are the electron hungry water clusters. If we take a water sample with an ORP reading of +350 mV those water clusters are very electron hungry and the water clusters are much larger than a water sample with an ORP reading of −350 mV whose water clusters are smaller and electron rich.

Consider again the aquaporin channels that Nobel winner Peter Agre is credited for discovering. Those aquaporin channels are not only very small but they are ionically charged, meaning they are electron hungry with a positive charge. If a large water cluster with a positive charge comes nearby an aquaporin, two things happen: the positive charges repel each other (just like two north poles of a magnet repel each other), and the water cluster is so large it has a hard time fitting through the narrow aquaporin channel. It's like fitting a large beach ball with sticky Velcro® on the outside and pushing it through the small doorway into the house. This makes it much harder to hydrate a plant (or water the plant) with large diameter electron hungry water clusters. The opposite is also true. A small diameter water cluster with a negative charge is electron rich, and will easily fit through the aquaporin channel and the negative electric charge makes it attractive to the aquaporin channel, making it even easier to go through the channel. The electrical charge and size of the water cluster make a huge difference in water absorption by a plant. Simply put, the smaller water cluster with extra electrons is absorbed much quicker into a plant, hydrating it better with an antioxidant effect and creating a healthier plant.

### The Shape Of Water Clusters And Its Effects On The Absorption Of Water

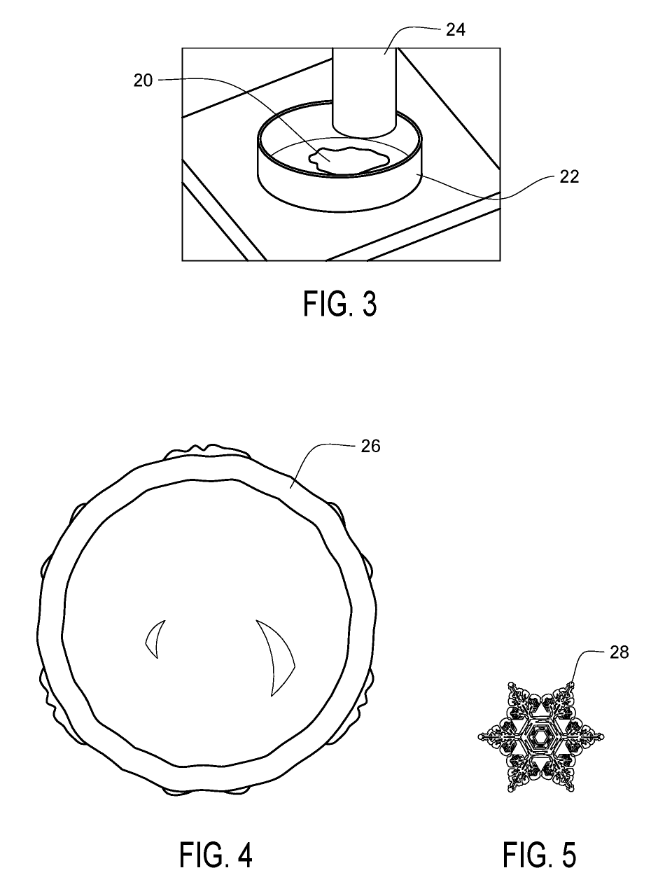

Dr. Masaru Emoto created the Hado institute in Japan. Dr. Emoto focused on helping heal people with water and discovered many properties water has. He knew water was like a recording instrument capable of absorbing energy from a room and its surroundings. To show how water shapes changed, Dr. Emoto and a group of Japanese scientists developed a way to film water crystals that grew out of a sample of water as the water sample froze. What was the shape of the ice crystals produced from that water sample? Ice crystals have an almost infinite number of shapes that can form. Dr. Emoto remembered the saying “No two snowflakes are alike!” Dr. Emoto speculated that this was dependent upon the water the snowflakes came from. With their scientists, the Hado institute created a cold room where the temperature was always below freezing. The scientists wore clothing one would wear for the coldest winter days to work in that room. They developed a special camera that worked with a microscope in those temperatures to film the water crystals as they were forming. As shown in FIG. 3, a water sample 20 is placed into a petri dish 22 and the scientists would take pictures with a camera attached to a microscope 24 to record the shape of each ice crystal that would form while the water sample 20 froze, reflecting a lot of information about each water sample. Dr Emoto took water samples from New York City tap water. This water had an ORP reading of +320 mV and no dissolved hydrogen, meaning it was a large water cluster and electron hungry. The ice crystal 26 that formed is shown in FIG. 4, and has a large, round shape like a beach ball. Dr. Emoto took a water sample that had been run through a home Jupiter Ionizer. This water sample had an ORP reading of −375 mV and had dissolved hydrogen of 400 ppb. The ice crystal 28 that formed is shown in FIG. 5 and has a three dimension six sided Christmas tree shape. Not only was the water crystal smaller in size, it changed from a round shape into a Christmas tree shape with even more surface area to share electrons.

### Making Water That Is Healthier For Plants

One method for making water healthier for plants utilizes very specific electrolysis units. A second method utilizes adding chemicals to the water. Both methods can create water with a negative mV ORP reading that has smaller water clusters and extra electrons to give to the plant.

Water that is healthier for plants can be made with an electrolysis unit. Inside an electrolysis unit, the water passes into an electrolysis chamber equipped with electrodes where electrolysis takes place. Cations, positive ions, gather at the negative electrodes to create cathodic water (structured micro-water or reduced water). Anions, negatively charged ions, gather at the positive electrode to make anodic water (oxidized water). There are many different designs and shapes and materials used in making electrolysis unit chambers. Many different designs can be used to make water with smaller clusters and a healthy negative mV ORP reading.

Chemically, water with extra electrons to share can be made by adding chemicals, such as potassium carbonate with potassium hydroxide for example. These chemicals will change the structure of the water. It will give the water a strong negative mV ORP reading depending on the quantities used. These chemicals can be very expensive on a large scale and it is unknown if each plant variety wants all of that potassium, or if the extra potassium would be harmful or helpful for a plant. One skilled in the art will recognize that other chemicals may also be used to achieve a strong negative mV ORP reading.

### Dissolved Hydrogen In Water

Hydrogen is the most abundant element in the universe and a building block for plants. Hydrogen is simply one of the essential elements for plant growth. Hydrogen can be absorbed by plants through the air and through water. Rain water, ground water, municipal water, and spring water contain very little dissolved hydrogen (0-10 ppb). Recently, researchers in China preliminarily studied hydrogen effects on higher plants. The results show that the hydrogen has important regulatory effects on plant physiological function, and especially plays an important role in plant resistance to stress. Hydrogen water treatment can promote the growth of the plant. A study in China found that hydrogen can regulate the expression of receptor protein genes of many plant hormones, including some plant hormones associated with disease resistance. Irrigation of crops by the use of hydrogen water will likely improve crop resistance to pests and diseases.

The macro elements in plants are carbon, hydrogen and oxygen. Increasing the amount of dissolved hydrogen in the water used for agriculture is very beneficial. Hydrogen is instantly absorbed by plants to increase their health and growth rate. Rates of change in growth rate will be dependent on plant type and the levels of dissolved hydrogen they are exposed to. As stated above, water clusters from rain water, ground water, surface water, or municipal water sources have very little dissolved hydrogen (0-10 ppb) and usually test out with zero dissolved hydrogen. Water clusters with dissolved hydrogen of 1 to 9 ppb may have some benefit, but the 10 ppb to 10,000 ppb range is more beneficial. Since the dissolved hydrogen can escape from the water gradually over time, the dissolved hydrogen water should be applied to the plants as quickly as possible to achieve the best results.

### Dissolving Hydrogen In Water

There are two methods that can be used to dissolve hydrogen in water. One method uses ionization/electrolysis to create dissolved hydrogen. The additional dissolved hydrogen levels from 10 ppb to 10,000 ppb can be created with custom ionization equipment. The method starts with water free of plant toxins, chemicals, or adulterants, and is then custom processed to ionize the water within the specifications outlined above. The ionization equipment has chambers which exposes the water to a specific current (voltage, amperage, frequency, and electrical wave shape) to draw hydrogen out of the water molecule. Membranes of different materials are used to keep the dissolved hydrogen on one side of the chamber, where we can then use that water to irrigate plants. Adding hydrogen reduces the size of the water clusters, and changes the electrical charge of the water clusters measured in negative mV. There are many different designs of ionization/electrolysis equipment that can create such structured micro-water (as is known in the art).

A second method used to dissolve hydrogen in water adds chemicals to the water. Dissolved hydrogen can be created using chemicals such as magnesium malate, magnesium fumarate, malic acid, and fumaric acid. Using these chemicals together will let hydrogen bubble and percolate through the water. If kept in an aluminum container the hydrogen can stay in the water for long periods of time and used later for plant irrigation. Otherwise, the water with dissolved hydrogen should be applied to the plants as soon as possible. There is currently no equipment developed to use this chemical method to create water in quantities large enough for crop irrigation.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood by those skilled in the art that many changes in construction and widely differing embodiments and applications will suggest themselves without departing from the scope of the disclosed subject matter.

What is claimed is:

1. A method for irrigation, the method comprising the steps of:
(a) treating a source water by a process;
(b) yielding, from the process, a structured micro-water having an oxidation reduction potential reading of −1 mV to −1100 mV; and
(c) irrigating a plant with the structured micro-water, wherein the plant experiences increased absorption, accelerated plant growth, better plant health, and greater quality and quantity of plant yield.

2. The method according to claim 1 wherein step (a) further comprises the step of:
treating the source water by an electrolysis process and thereby reducing a size of water clusters in the structured micro-water compared to a size of water clusters in the source water.

3. The method according to claim 2 further comprising the step of:
reducing by the electrolysis process the number of molecules in the water clusters in the structured micro-water compared to the number of molecules in the water clusters in the source water.

4. The method according to claim 1 further comprising the step of:
filtering the source water to remove unwanted substances thereby enhancing the quality of the water prior to treating step (a).

5. The method according to claim 1 wherein step (a) further comprises the steps of:
treating the source water by adding a chemical and thereby reducing a size of water clusters in the structured micro-water compared to a size of water clusters in the source water.

6. The method according to claim 5 wherein the chemical used for treating the source water is potassium carbonate with potassium hydroxide.

7. A method for irrigation, the method comprising the steps of:
(a) treating a source water by a process;
(b) yielding, from the process, a structured micro-water having a dissolved hydrogen content of 10 ppb to 10,000 ppb; and
(c) irrigating a plant with the structured micro-water, wherein the plant experiences accelerated plant growth, better plant health, greater quality and quantity of plant yield, and reduced oxidative stress.

8. The method according to claim 7 wherein step (a) further comprises the step of:
treating the source water by an electrolysis process and thereby creating the dissolved hydrogen, reducing a size of water clusters in the structured micro-water compared to a size of water clusters in the source water, and yielding a negative charge of the water clusters in the structured micro-water.

9. The method according to claim 8 further comprising the step of:
reducing by the electrolysis process the number of molecules in the water clusters in the structured micro-water compared to the number of molecules in the water clusters in the source water.

10. The method according to claim 7 further comprising the step of:
filtering the source water to remove unwanted substances thereby enhancing the quality of the water prior to treating step (a).

11. The method according to claim 7 wherein step (a) further comprises the steps of:
treating the source water by adding a chemical and thereby creating the dissolved hydrogen.

12. The method according to claim 11 wherein the chemical used for treating the source water is selected from the group consisting of magnesium malate, magnesium fumarate, malic acid, and fumaric acid.
